(19) United States
(12) Patent Application Publication
(10) Pub. No.: US 2026/0126308 A1
(43) Pub. Date: May 7, 2026

(54) SENSOR PROTECTION STRUCTURE

(71) Applicant: TOYOTA JIDOSHA KABUSHIKI KAISHA, Toyota-shi (JP)

(72) Inventor: Yutaka HIGASHI, Toyota-shi (JP)

(21) Appl. No.: 19/339,323

(22) Filed: Sep. 25, 2025

(30) Foreign Application Priority Data
Nov. 6, 2024 (JP) 2024-194641

(51) Int. Cl. G01D 11/24; G01D 11/26

(52) U.S. Cl. CPC G01D 11/245; G01D 11/26

(57) ABSTRACT

A sensor protection structure includes: a design member provided at a front part of a vehicle and configuring an outer face of the vehicle; a sensor having a sensor front face oriented toward a vehicle forward side, and having a groove formed at a portion at a vehicle rearward side of the sensor front face, the groove being configured to discharge water; and a sensor cover covering the sensor from the vehicle forward side in a state attached to the design member.

### CROSS-REFERENCE TO RELATED APPLICATION

This application is based on and claims priority under 35 USC 119 from Japanese Patent Application No. 2024-194641, filed on November 6, 2024, the entire disclosure of which is incorporated by reference herein.

### BACKGROUND

### TECHNICAL FIELD

The present disclosure relates to a sensor protection structure.

### Related Art

Japanese Patent Application Laid-Open (JP-A) No. 2020-51778 discloses a vehicle sensor unit that suppresses foreign matter from adhering to a lens surface of an optical sensor. The vehicle sensor unit described in this document is provided with a sealing material having an infrared radar device that transmits infrared rays toward a vehicle exterior (to a front side of the vehicle) and receives infrared rays reflected from an object outside the vehicle, and a cover that is positioned in front of the infrared radar device in the infrared transmission direction, that covers the infrared radar device, and that allows infrared radiation to pass through the cover. In this way, by providing a cover that covers a sensor, such as an infrared radar device, from the vehicle front side, adhesion of foreign matter to the front face of the sensor can be suppressed.

As explained above, from the viewpoint of ensuring detection accuracy of the sensor and the like, it is important to suppress adhesion of foreign matter (such as water droplets) to the front face of the sensor.

### SUMMARY

The present disclosure provides a sensor protection structure, the protection structure being capable of suppressing adhesion of water droplets to a front face of a sensor.

A sensor protection structure of a first aspect includes: a design member provided at a front part of a vehicle and configuring an outer face of the vehicle; a sensor having a sensor front face oriented toward a vehicle forward side, and having a groove formed at a portion at a vehicle rearward side of the sensor front face, the groove being configured to discharge water; and a sensor cover covering the sensor from the vehicle forward side in a state attached to the design member.

In the sensor protection structure of the first aspect, in a state in which the sensor cover is attached to the design member, the sensor is covered from the vehicle front side by the sensor cover. This enables water droplets heading toward the sensor front face of the sensor to be blocked by the sensor cover. Further, when water droplets entering from between the sensor cover and the design member adhere to a portion at the vehicle rear side of the sensor front face of the sensor, the water droplets are discharged through a groove formed in the sensor. Thus, in the sensor protection structure of the first aspect, adhesion of water droplets to the sensor front face of the sensor can be suppressed.

A sensor protection structure of a second aspect is the sensor protection structure of the first aspect, in which the sensor cover is provided with an upper side cover portion that covers at least a part of the sensor from a vehicle upper side.

In the sensor protection structure of the second aspect, at least a part of the sensor is covered from the vehicle upper side by an upper side cover portion of the sensor cover. In this configuration, compared to a configuration using a sensor cover that does not include an upper side cover portion, it is possible to suppress adhesion of water droplets that have entered from between the sensor cover and the design member to a portion of the sensor at the vehicle upper side.

A sensor protection structure of a third aspect is the sensor protection structure of the first aspect, in which a labyrinth structure portion is provided between the design member and the sensor cover.

In the sensor protection structure of the third aspect, the provision of the labyrinth structure portion between the design member and the sensor cover enables entry of water droplets into the sensor side from between the sensor cover and the design member to be suppressed.

The sensor protection structure according to the present disclosure has the excellent effect of enabling adhesion of foreign matter to the front face of a sensor to be suppressed.

### BRIEF DESCRIPTION OF THE DRAWINGS

Exemplary embodiments of the present disclosure will be described in detail based on the following figures, wherein:

FIG. 1 is a front view from the vehicle front side of a design member provided at a front portion of a vehicle;

FIG. 2 is a side view illustrating a sensor provided inside a design member, and illustrating a cross-section of a design member and a sensor cover taken along line 2-2 illustrated in FIG. 1;

FIG. 3 is a view corresponding to FIG. 2, illustrating a sensor or the like to which a sensor protection structure according to a second exemplary embodiment is applied;

FIG. 4 is a view corresponding to FIG. 2, illustrating a sensor or the like to which a sensor protection structure according to a third exemplary embodiment is applied;

FIG. 5 is a view corresponding to FIG. 2, illustrating a sensor or the like to which a sensor protection structure according to a fourth exemplary embodiment is applied;

FIG. 6 is a view corresponding to FIG. 2, illustrating a sensor or the like to which a sensor protection structure according to a fifth exemplary embodiment is applied;

FIG. 7 is a view corresponding to FIG. 2, illustrating a sensor or the like to which a sensor protection structure according to a sixth exemplary embodiment is applied;

FIG. 8 is a view corresponding to FIG. 2, illustrating a sensor or the like to which a sensor protection structure according to a seventh exemplary embodiment is applied; and

FIG. 9 is a view corresponding to FIG. 2, illustrating a sensor or the like to which a sensor protection structure according to an eighth exemplary embodiment is applied.

### DETAILED DESCRIPTION

### (First Exemplary Embodiment)

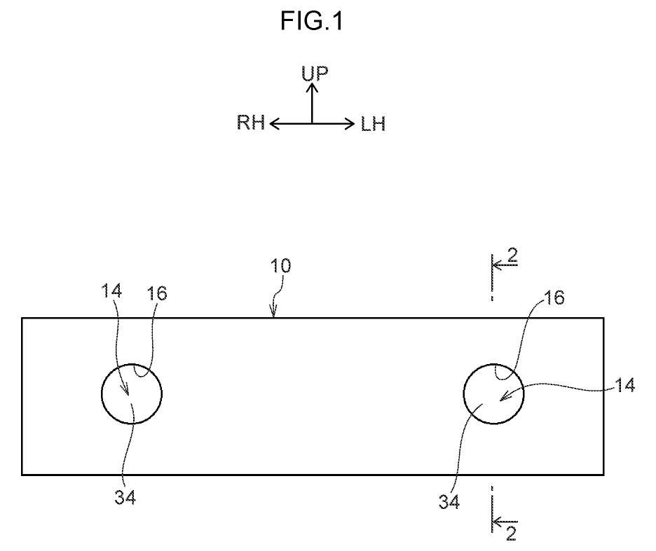

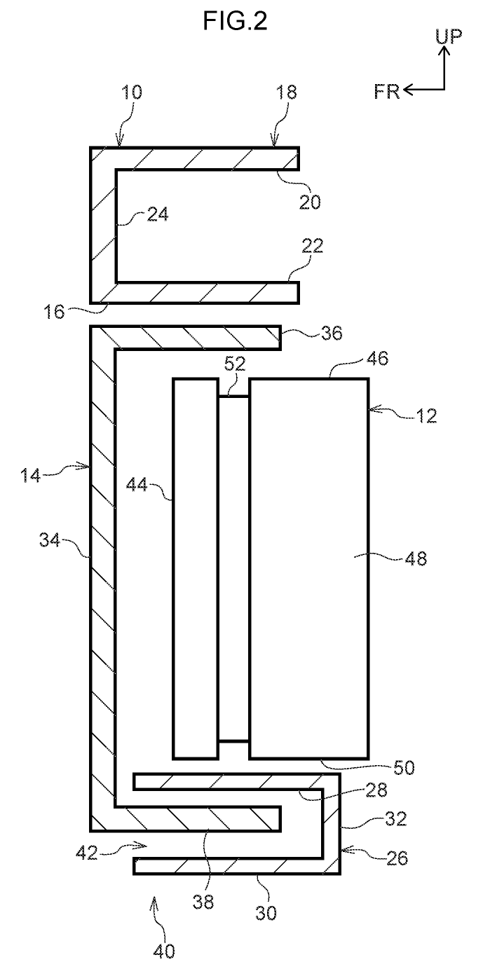

Explanation follows regarding a structure of a front portion of a vehicle to which a sensor protection structure according to a first exemplary embodiment of the present disclosure is applied, with reference to FIGS. 1 and 2. Here, in each of the drawings, as appropriate, the arrow FR indicates the vehicle front side, the arrow UP indicates the vehicle upper side, the arrow LH indicates the left side in the vehicle width direction (left-right direction), and the arrow RH indicates the right side in the vehicle width direction (left-right direction). Further, unless specifically stated otherwise, in the following explanation, reference to the front and rear, up and down, and left and right directions refers to front and rear in the vehicle front-rear direction, up and down in the vehicle vertical direction, and left and right in the vehicle left-right direction.

FIGS. 1 and 2 illustrate a design member 10 provided at a front portion of a vehicle. The design member 10 is a grill or a bumper configuring an outer face of a front portion of a vehicle. A sensor 12 is provided inside the design member 10, and the sensor 12 is covered from the front side by a sensor cover 14 attached to the design member 10.

Circular openings 16 are respectively formed at both left and right sides of the design member 10. Sensors 12 are provided at positions corresponding to these circular openings 16, respectively, when viewing the design member 10 from the front side. As illustrated in FIG. 2, in a cross-section view taken along the vertical direction and the front-rear direction at a portion corresponding to the opening 16 in the design member 10, an upper portion of the opening 16 of the design member 10 is an upper U-shaped cross-section portion 18 formed in a U-shaped cross-section with a rear side open. The upper U-shaped cross-section portion 18 includes an upper wall 20 and a lower wall 22 that are disposed apart from each other in the vertical direction, and a front wall 24 that connects a front end of the upper wall 20 and a front end of the lower wall 22 in the vertical direction. Further, in a cross-section view taken along the vertical direction and the front-rear direction at a portion corresponding to the opening 16 in the design member 10, a lower portion of the opening 16 of the design member 10 is a lower U-shaped cross-section portion 26 formed in a U-shaped cross-section with a front side open. The lower U-shaped cross-section portion 26 includes an upper wall 28 and a lower wall 30 that are disposed apart from each other in the vertical direction, and a rear wall 32 that connects a rear end of the upper wall 28 and a rear end of the lower wall 30 in the vertical direction.

As illustrated in FIG. 2, a sensor cover 14 is formed in a circular shape corresponding to the opening 16 formed in the design member 10 as viewed from the front side, and a front side cover portion 34 is provided extending in the vertical direction and the left-right direction with the front-rear direction as a thickness direction. Further, the sensor cover 14 includes an upper side cover portion 36 extending toward a rear side from a portion at an upper side of the front side cover portion 34, and a lower side cover portion 38 extending toward a rear side from a portion at a lower side of the front side cover portion 34. Further, in a state in which the sensor cover 14 is attached to the design member 10, the front side cover portion 34 is disposed so as to close the opening 16 from the front side. Further, in a state in which the sensor cover 14 is attached to the design member 10, the upper side cover portion 36 extends in the front-rear direction in a state in which it has clearance in the vertical direction with the lower wall 22 of the upper U-shaped cross-section portion 18 of the design member 10. In addition, in a state in which the sensor cover 14 is attached to the design member 10, the lower side cover portion 38 is in a state inserted from the front side into the lower U-shaped cross-section portion 26 of the design member 10. The lower side cover portion 38 extends in the front-rear direction in a state in which it has clearance in the vertical direction with the upper wall 28 and the lower wall 30 of the lower U-shaped cross-section portion 26, and in a state in which it has clearance in the front-rear direction with the rear wall 32 of the lower U-shaped cross-section portion 26. As a result, a labyrinth structure portion 40 is formed by the lower side cover portion 38 and the lower U-shaped cross-section portion 26. A U-shaped gap 42 that is open at the front side is formed between the lower side cover portion 38 and the lower U-shaped cross-section portion 26 configuring the labyrinth structure portion 40.

The sensor 12 is, for example, a millimeter wave radar, a rider, a camera, or the like, and is formed in a rectangular block shape in the present exemplary embodiment. The front face of the sensor 12 is a sensor front face 44 facing the front side. Further, angular groove-shaped grooves 52 for discharging water droplets adhering to portions of the sensor 12 further toward the rear than the sensor front face 44 are formed at an upper portion 46, left and right side portions 48, and a lower portion 50 of the sensor 12. The groove 52 at the upper portion 46 of the sensor 12 is open at the upper side, and extends in the left-right direction. Further, the groove 52 at the left and right side portions of the sensor 12 is open at the left side or the right side, and extends in the vertical direction. In addition, the groove 52 at the lower portion 50 of the sensor 12 is open at the lower side and extends in the left-right direction. Further, the grooves 52 formed in the respective portions of the sensor 12 are connected to each other. The sensor 12 is fixed to a sensor fixing portion, not illustrated in the drawings, provided at the side of the vehicle body. Further, most of the sensor 12 is disposed between the lower wall 22 of the upper U-shaped cross-section portion 18 and the upper wall 28 of the lower U-shaped cross-section portion 26 of the design member 10. Further, a front side portion of the sensor 12 is covered by the front side cover portion 34, the upper side cover portion 36, and the lower side cover portion 38 of the sensor cover 14 attached to the design member 10. Here, a rear end of the upper side cover portion 36 and a rear end of the lower side cover portion 38 are positioned at a rear side of the grooves 52 formed in the sensor 12.

### (Mechanism and Effects of Present Exemplary Embodiment)

Next, explanation is provided regarding the mechanism and effects of the present exemplary embodiment.

In the present exemplary embodiment explained above, in a state in which the sensor cover 14 is attached to the design member 10, a front side portion of the sensor 12 is covered by a front side cover portion 34, an upper side cover portion 36, and a lower side cover portion 38 of a sensor cover 14 attached to the design member 10. As a result, droplets of water directed toward the sensor front face 44 of the sensor 12 can be blocked by the sensor cover 14.

Further, when water droplets entering from between the sensor cover 14 and the design member 10 (for example, between the lower wall 22 of the upper U-shaped cross-section portion 18 and the upper side cover portion 36 of the sensor cover 14) adhere to a portion (e.g., the upper portion 46) at the vehicle rear side of the sensor front face 44 of the sensor 12, the water droplets are discharged downward through the grooves 52 formed in the sensor 12. In this manner, in the present exemplary embodiment, adhesion of water droplets to the sensor front face 44 of the sensor 12 can be suppressed.

Further, in the present exemplary embodiment, a front side portion of the upper portion 46 of the sensor 12 is covered from above by the upper side cover portion 36 of the sensor cover 14. In this configuration, compared to a configuration in which a sensor cover 14 that does not include the upper side cover portion 36 is used, water droplets entering from between the sensor cover 14 and the design member 10 can be prevented from adhering to the upper portion 46 of the sensor 12.

In addition, in the present exemplary embodiment, a labyrinth structure portion 40 is formed by the lower side cover portion 38 of the sensor cover 14 and the lower U-shaped cross-section portion 26 of the design member 10. As a result, it is possible to suppress entry of water droplets to the side of the sensor 12 from between the lower side cover portion 38 of the sensor cover 14 and the lower U-shaped cross-section portion 26 of the design member 10.

Here, in the present exemplary embodiment, while an example has been explained in which the labyrinth structure portion 40 is provided, the present disclosure is not limited thereto. Whether or not to provide the labyrinth structure portion 40 may be appropriately determined in view of whether or not to adopt another sealing member, for example.

### (Other Aspects of Sensor Protection Structure)

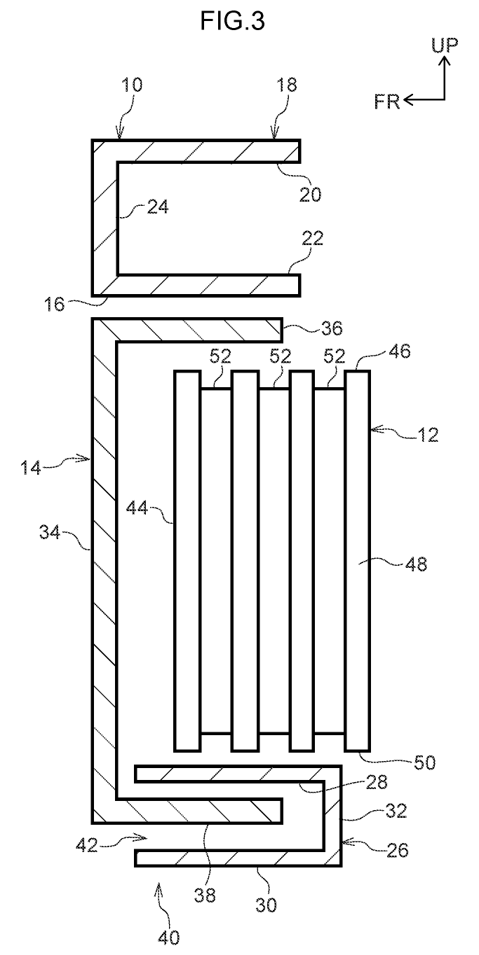

Next, explanation is given regarding sensor protection structures of second to eighth exemplary embodiments, with reference to FIGS. 3 to 9. Here, in the members and portions configuring the sensor protection structure of the second to the eighth exemplary embodiments, members and portions corresponding to those configuring the sensor protection structure of the first exemplary embodiment described above are appended with the same reference numerals as those of the corresponding members and portions configuring the sensor protection structure of the first exemplary embodiment, and explanation thereof may be omitted.

As illustrated in FIG. 3, in the sensor protection structure of the second exemplary embodiment, a plurality of grooves 52 that are spaced apart in the front-rear direction are formed in the sensor 12. In this configuration, water droplets adhering to a portion at the vehicle rearward side of the sensor front face 44 of the sensor 12 can be discharged downward through the groove 52. As a result, adhesion of water droplets to the sensor front face 44 of the sensor 12 can be suppressed.

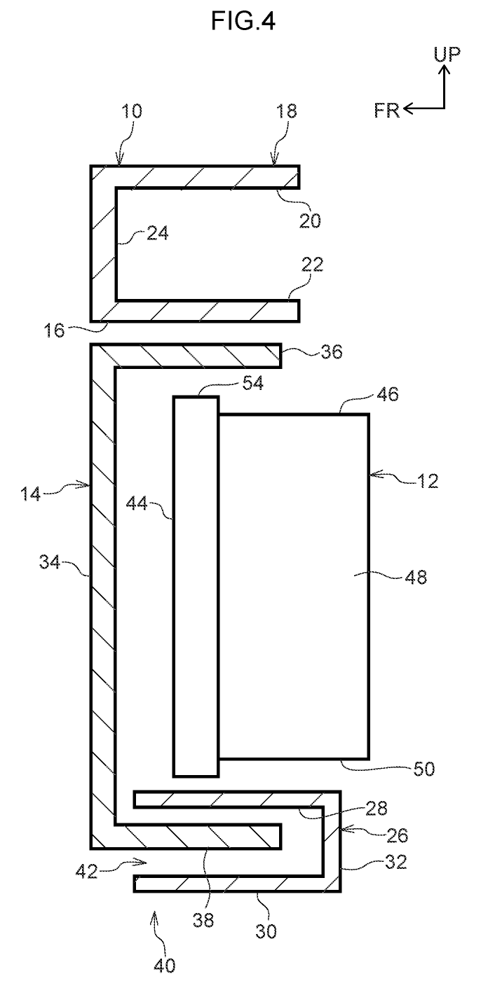

As illustrated in FIG. 4, in the sensor protection structure of the third exemplary embodiment, flange portions 54 that protrude toward the upper side, both left and right direction sides, and the lower side are formed at portions at the front side of the sensor 12. In this configuration, water droplets adhering to a portion at the vehicle rearward side of the sensor front face 44 of the sensor 12 can be blocked by the flange portion 54. As a result, adhesion of water droplets to the sensor front face 44 of the sensor 12 can be suppressed.

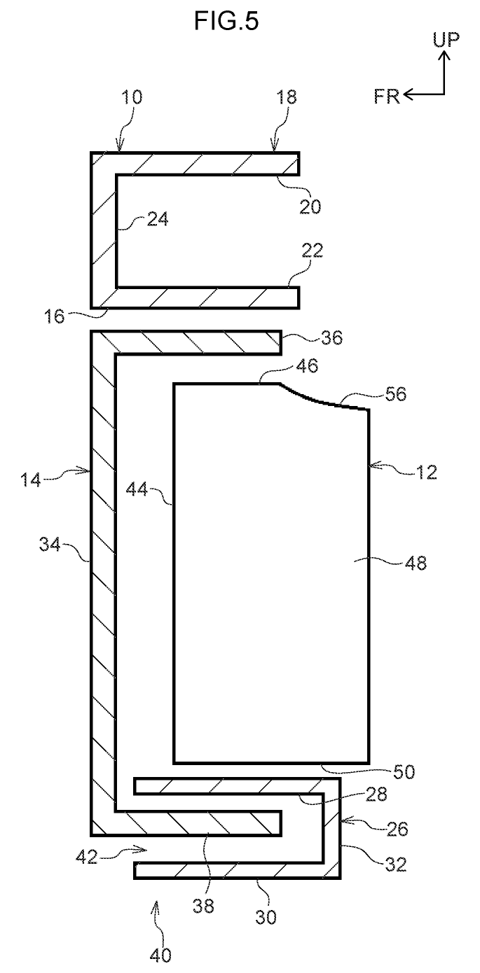

As illustrated in FIG. 5, in the sensor protection structure of the fourth exemplary embodiment, a recess 56 for receiving and directing water droplets attached to a portion at the rear side of the upper portion 46 of the sensor 12 toward the rear side is formed at a portion at the rear side of the upper portion 46 of the sensor 12. In this configuration, water droplets adhering to a portion at the rear side of the upper portion 46 of the sensor 12 can be received and guided toward the rear side via the recess 56. As a result, adhesion of water droplets to the sensor front face 44 of the sensor 12 can be suppressed.

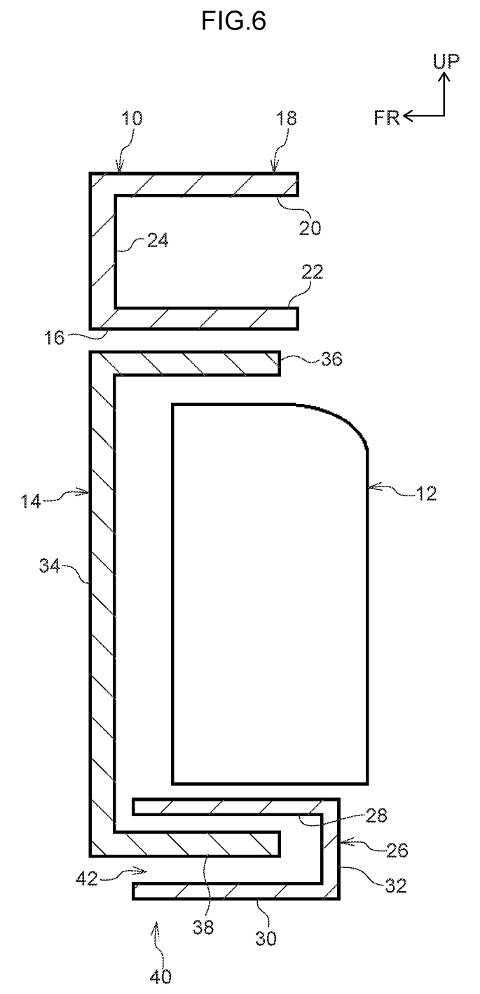

As illustrated in FIG. 6, in the sensor protection structure of the fifth exemplary embodiment, a curved portion 58 for receiving and directing water droplets adhering to a portion at a rear side of the upper portion 46 of the sensor 12 toward a rear side is formed at a portion at a rear side of the upper portion 46 of the sensor 12. The upper face of the curved portion 58 is gently curved toward the lower side on progression toward the rear side. In this configuration, water droplets adhering to a portion at the rear side of the upper portion 46 of the sensor 12 can be received and guided toward the rear side via the curved portion 58. As a result, adhesion of water droplets to the sensor front face 44 of the sensor 12 can be suppressed.

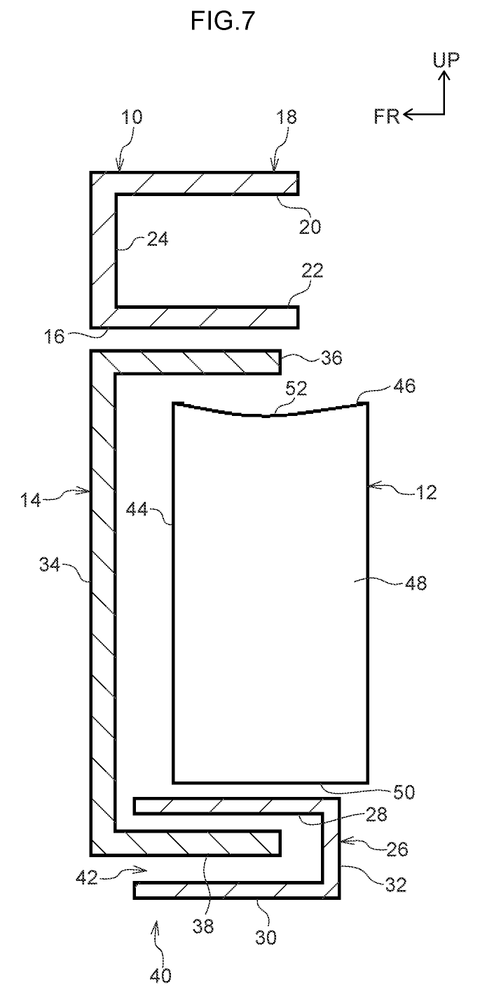

As illustrated in FIG. 7, in the sensor protection structure of the sixth exemplary embodiment, a groove 52 is formed at the upper portion 46 of the sensor 12 for receiving and directing water droplets adhering to the upper portion 46 of the sensor 12 toward a side (right side or left side). The depth of the groove 52 becomes increasingly deeper from the front end and rear end of the upper portion 46 of the sensor 12 toward the center portion in the front-rear direction. In this configuration, water droplets adhering to the upper portion 46 of the sensor 12 can be received and made to flow sideward through the groove 52. As a result, adhesion of water droplets to the sensor front face 44 of the sensor 12 can be suppressed.

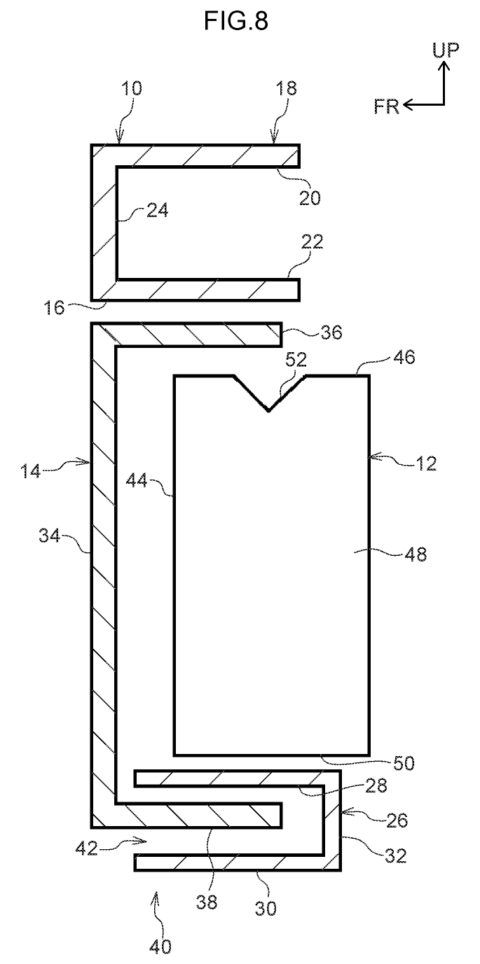

As illustrated in FIG. 8, in the sensor protection structure of the seventh exemplary embodiment, a V-shaped groove 52 is formed in the upper portion 46 of the sensor 12 for receiving and directing water droplets adhering to the upper portion 46 of the sensor 12 toward a side (right side or left side). The groove 52 is formed at a center portion in the front-rear direction of the upper portion 46 of the sensor 12. In this configuration, water droplets adhering to the upper portion 46 of the sensor 12 can be received and made to flow sideward through the groove 52. As a result, adhesion of water droplets to the sensor front face 44 of the sensor 12 can be suppressed.

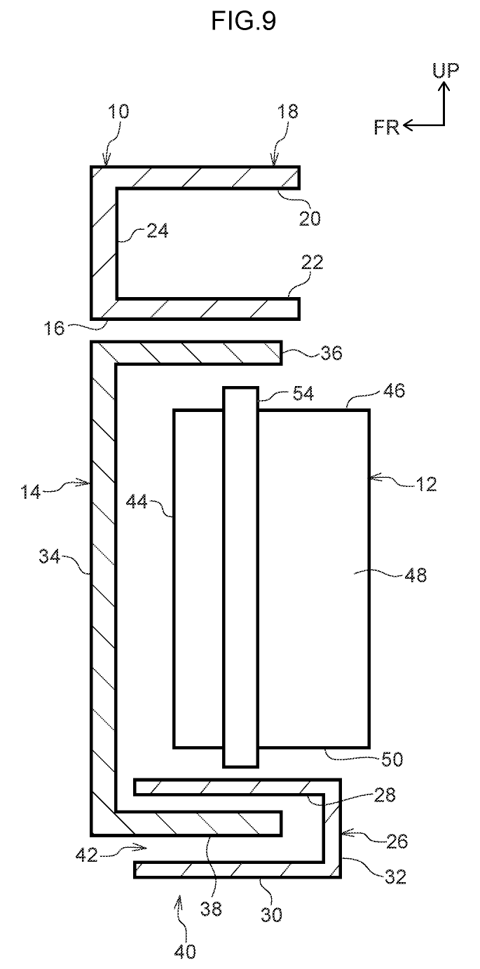

As illustrated in FIG. 9, in the sensor protection structure of the eighth exemplary embodiment, flange portions 54 that protrude toward the upper side, both left and right direction sides, and the lower side are formed at an intermediate portion in the front-rear direction of the sensor 12. In this configuration, water droplets adhering to a portion at the vehicle rear side of the flange portion 54 of the sensor 12 can be blocked by the flange portion 54. As a result, adhesion of water droplets to the sensor front face 44 of the sensor 12 can be suppressed.

Although one exemplary embodiment of the present disclosure has been explained above, the present disclosure is not limited to the foregoing. Needless to say, various modifications other than the above may be implemented within a range that does not depart from the spirit of the present disclosure.

What is claimed is:

1. A sensor protection structure, comprising:
a design member provided at a front part of a vehicle and configuring an outer face of the vehicle;
a sensor having a sensor front face oriented toward a vehicle forward side, and having a groove formed at a portion at a vehicle rearward side of the sensor front face, the groove being configured to discharge water; and
a sensor cover covering the sensor from the vehicle forward side in a state attached to the design member.

2. The sensor protection structure of claim 1, wherein the sensor cover is provided with an upper side cover portion that covers at least a part of the sensor from a vehicle upper side.

3. The sensor protection structure of claim 1, wherein a labyrinth structure portion is provided between the design member and the sensor cover.
